(19) United States
(12) Patent Application Publication
(10) Pub. No.: US 2017/0237169 A1
(43) Pub. Date: Aug. 17, 2017

(54) ANTENNA SYSTEM HAVING A SET OF INVERTED-F ANTENNA ELEMENTS

(71) Applicant: TYCO ELECTRONICS CORPORATION, Berwyn, PA (US)

(72) Inventors: Kathleen Fasenfest, Union City, CA (US); Dao Dinh Nguyen, San Jose, CA (US)

(21) Appl. No.: 15/088,187

(22) Filed: Apr. 1, 2016

Related U.S. Application Data
(60) Provisional application No. 62/295,879, filed on Feb. 16, 2016.

(51) Int. Cl. H01Q 5/50; H01Q 1/48; H01Q 9/04

(52) U.S. Cl. CPC H01Q 5/50; H01Q 9/045; H01Q 1/48

(57) ABSTRACT

Antenna system includes a ground structure and a set of inverted-F antenna (IFA) elements that are configured to be fed by a feed network. Each of the IFA elements has an arm that is spaced apart from the ground structure by a designated height and extends along the ground structure for at least a portion of the arm. Each of the IFA elements has a shorting stub that is coupled to the arm and to the ground structure. The antenna system may be configured for wideband or multiband operation.

### CROSS-REFERENCE TO RELATED APPLICATION

The present application claims the benefit of U.S. Provisional Application No. 62/295,879, filed on Feb. 16, 2016, which is incorporated herein by reference in its entirety.

### BACKGROUND

The subject matter disclosed herein relates to antenna systems having a plurality of antenna elements that are controlled to provide wideband or multi-band operation.

A variety of systems and devices use antennas to wirelessly communicate information during operation of the system or device. The capability of communicating at multiple different frequency bands or within a wide band of frequencies is often desired. For example, many devices now operate within multiple frequency bands and are capable of selecting such bands for different networks. In some cases, it also desirable to reduce the size or footprint of the antenna. For example, automobiles may have antennas that are shaped to minimize drag caused by the antennas. As another example, consumers have a general demand for wireless communication devices (e.g., mobile phones, portable computers) that are smaller. However, consumers also desire better performance and/or a greater number of capabilities. To provide smaller devices with improved performance and more capabilities, manufacturers have attempted to optimize the configuration of the antenna, among other things.

One common type of antenna is the inverted-F antenna (IFA). An IFA includes a radiating structure that extends parallel to a ground plane and is fed by a radio-frequency (RF) source. The IFA also includes a shorting stub that electrically couples the radiating structure to the ground plane. One disadvantage of IFAs is that the bandwidth of the IFA decreases as the distance between the radiating structure and the ground plane decreases. In other words, the bandwidth of the IFA reduces as the height of the IFA reduces. Thus, IFAs may not be suitable for certain applications in which shorter antennas are required.

Accordingly, there is a need for alternative antenna configurations that provide a sufficient bandwidth but also have a smaller size and/or footprint than currently available antennas.

### BRIEF DESCRIPTION

In an embodiment, an antenna system is provided that includes a ground structure and a set of inverted-F antenna (IFA) elements that are configured to be fed by a feed network. Each of the IFA elements has an arm that is spaced apart from the ground structure by a designated height and extends along the ground structure for at least a portion of the arm. Each of the IFA elements has a shorting stub that is coupled to the arm and to the ground structure. The IFA elements may be configured for wideband or multiband operation.

In an embodiment, an antenna system is provided that includes a ground structure and a transmission line having first and second conductors. The antenna system also includes a set of inverted-F antenna (IFA) elements having different respective resonant frequencies. Each of the IFA elements has an arm that is spaced apart from the ground structure by a designated height and extends along the ground structure for at least a portion of the arm. Each of the IFA elements has a shorting stub that is coupled to the arm and to the ground structure. The set of IFA elements is configured to be fed by the transmission line in which adjacent IFA elements are fed by different conductors of the transmission line.

In an embodiment, an antenna system is provided that includes a ground structure and a set of inverted-F antenna (IFA) elements that are configured to be fed by a feed network. Each of the IFA elements has an arm that is spaced apart from the ground structure by a designated height and extends along the ground structure for at least a portion of the arm. Each of the IFA elements has a shorting stub that is coupled to the arm and to the ground structure. The IFA elements have respective resonant frequencies that are configured to form a log-periodic progression of frequencies for wideband operation.

In some embodiments, the IFA elements form IFA pairs in which the two IFA elements of each IFA pair are aligned with each other and positioned anti-parallel to each another. The IFA elements of each IFA pair may be configured to have the same resonant frequency.

### BRIEF DESCRIPTION OF THE DRAWINGS

FIG. 1 is a perspective view of an antenna system formed in accordance with an embodiment having a plurality of inverted-F antenna (IFA) elements.

FIG. 2 is a cross-section of the antenna system illustrating one of the IFA elements in greater detail.

FIG. 3 is a perspective view of an antenna system formed in accordance with an embodiment having a plurality of IFA elements.

FIG. 4 is a perspective view of an antenna system formed in accordance with an embodiment having a plurality of IFA elements.

FIG. 5 is a schematic diagram of an antenna system formed in accordance with an embodiment.

FIG. 6 is a perspective view of an antenna system in accordance with an embodiment.

FIG. 7 is a plan view of a feed network of the antenna system of FIG. 6.

FIG. 8 is a graph illustrating an average gain by elevation angle for the antenna system of FIG. 6.

FIG. 9 is a graph illustrating a relationship between return loss and frequency for the antenna system of FIG. 6.

FIG. 10 is a graph illustrating a relationship between peak vertically-polarized gain and frequency for the antenna system of FIG. 6.

### DETAILED DESCRIPTION

Embodiments set forth herein include antenna systems and apparatuses that include such antenna systems. The antenna systems described herein may be used in a variety of applications or implementations. For example, embodiments may be used in aircraft (e.g., commercial planes, military planes, etc.), vehicles (e.g., automobiles, locomotives, etc.), water vessels (e.g., passenger ships, cargo ships, naval ships, etc.), and wireless communication devices (e.g., smart phones, portable computers, etc.). The antenna systems may be positioned near or along a side of an apparatus, although it is contemplated that some the antenna systems may be internally located.

In some embodiments, the antenna system may form a low-profile antenna system that is disposed within an apparatus and/or secured along an exterior of the apparatus. For example, aircraft often include antenna systems that are secured to the fuselage and project into exterior space that surrounds the fuselage. Such antenna systems may increase drag, thereby increasing fuel costs, and can be dangerous to birds when airborne or nearby workers when moving on the ground. The low-profile antenna systems described herein may reduce drag and be less dangerous to nearby individuals or animals. The low-profile antenna systems may provide similar advantages for other forms of transportation (e.g., locomotives, ships, automobiles, etc.). The low-profile antenna systems may also be used with portable devices.

Although certain embodiments may be described in relation to low-profile systems, it should be understood that embodiments set forth herein are not required to be low-profile antenna systems or include low-profile antenna systems.

Antenna systems may include a ground structure and a set of antenna elements. The ground structure may include only a single ground plane or a plurality of ground planes. If more than one ground plane is used, the ground planes may or may not be electrically connected or coupled to one another. The antenna elements may be, for example, stamped form sheet metal and, optionally, shaped. The antenna elements may also be etched, deposited, or otherwise disposed along a circuit board. Optionally, the antenna system may include a support block that is positioned between the antenna elements and the ground structure. The support block may be shaped to conform with the shape of the antenna elements and/or permit portions of the antenna elements to extend through the support block. In addition to the support block, the antenna system may include an enclosure (e.g., radome) that protects the antenna elements from external elements (e.g., wind, rain, objects). The enclosure may be constructed of a material that minimally attenuates the electromagnetic signals.

The antenna elements may have an inverted-F configuration and, as such, are hereinafter referred to as inverted-F antenna (IFA) elements. It is understood, however, that a variety of IFA configurations exist and are possible. IFA elements include an arm that is spaced apart from the ground structure and a shorting stub that couples or connects the arm to the ground structure. At least a portion of the arm extends along (e.g., parallel to) the ground structure. In particular embodiments, the arm has only a single planar body. In other embodiments, however, a single IFA element may include multiple arms connected to one another in which at least one of the arms extends along the ground structure. The panel bodies may be oriented, for example, parallel to or perpendicular to the ground structure. The IFA elements may be vertically polarized.

The IFA elements of a single set may have different configurations such that the IFA elements resonate at different respective frequencies. For example, the size and shape of the arm, the location of the feed point along the arm, and the size and shape of the shorting stub may be configured to achieve a desired performance. Optionally, the set of IFA elements may be controlled as a group by a feed network. The feed network may also have various configurations. For example, the feed network may be a single transmission line having a pair of conductors in which the conductors convey opposite phases. The set of IFA elements may be fed using a traveling-wave technique that is similar to those used for log-periodic dipole arrays (LPDAs). Thus, one or more antenna systems may be operated with only a single transmission line.

Optionally, the transmission line may be a balanced line (e.g., twin-feed line) or an unbalanced line. Unbalanced lines may be formed from microstrip or coaxial lines. The transmission lines may also be fed using baluns, such as Marchand baluns or tapered-line baluns.

In other embodiments, the feed network may include multiple different feeds or lines. For example, a first transmission line may control one or more of the IFA elements and a second transmission line may control one or more of the IFA elements. Alternatively, each of the IFA elements may be controlled individually such that the set of the IFA elements, as a group, provide a wideband or multi-band communication system.

In particular embodiments, the IFA elements are configured in a log-periodic arrangement. For example, the set of IFA elements may be configured to have a log-periodic progression of lengths, diameters (or like dimensions), and/or spacings or gaps between one another. In such embodiments, a wideband array may be provided that is capable of functioning while electrically close to the ground structure. However, embodiments are not required to have IFA elements with a log-periodic arrangement.

Compared to known systems, the antenna systems of some embodiments may offer more bandwidth for a designated antenna height above a ground structure or offer more gain for a designated bandwidth and height. Unlike LPDAs, which have a forward-facing beam, the antenna systems set forth herein may optionally have less beam in the forward-facing direction. For example, the set of IFA elements may be configured to provide radiation patterns that are more azimuthally symmetric than the radiation patterns of LPDAs. Unlike LPDAs, which have fixed impedances, each of the IFA elements in some embodiments may have a selectable impedance. Also unlike LPDAs, the arms of the IFA elements in some embodiments are not required to increase in size as the IFA elements progress toward a terminal line end.

As described herein, antenna systems may be configured for broadband operation. In some embodiments, the antenna systems are configured for wideband operation. For example, the antenna system may be configured to transmit and/or receive within a band of 118-137 MHz. In other embodiments, the antenna system may be configured for multi-band operation that includes at least two frequency bands. For example, the antenna system may be configured to transmit and/or receive within a band of 108-174 MHz and within a band of 950-1260 MHz. Another example of a frequency band that may be used is a band of 225-400 MHz. However, it should be understood that antenna systems described herein are not limited to particular frequency bands and other frequency bands may be used.

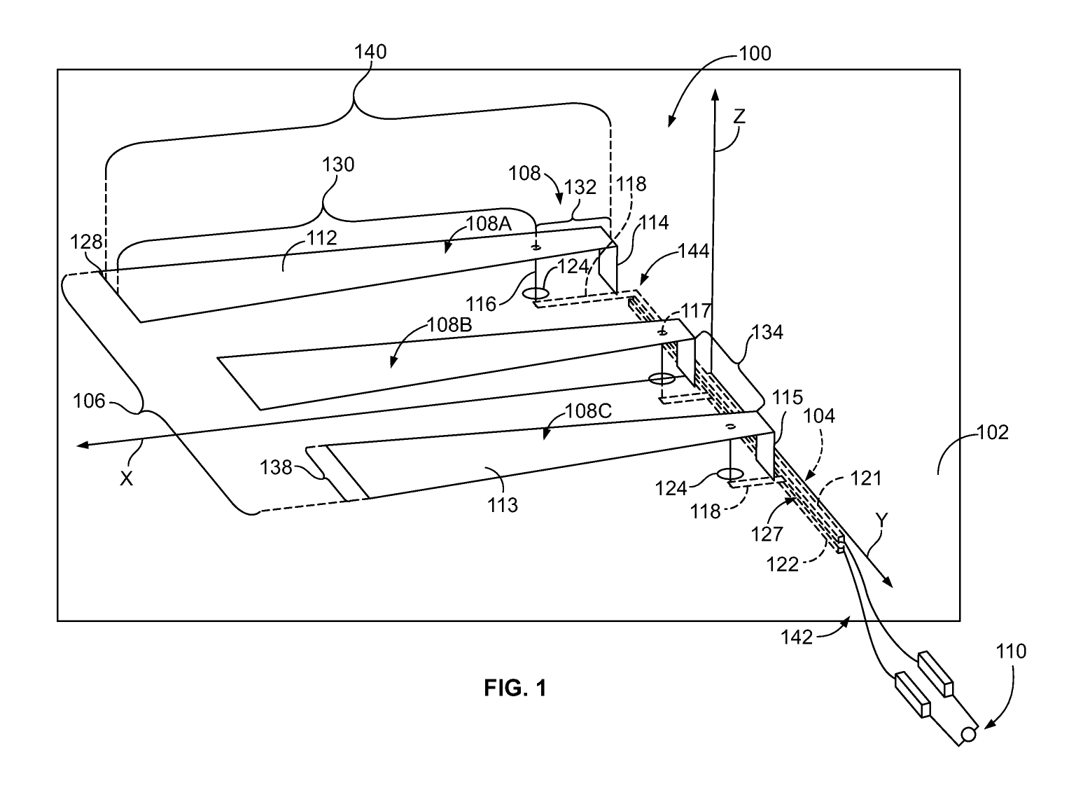

FIG. 1 is a perspective view of an antenna system 100 formed in accordance with an embodiment. The antenna system 100 may include a ground structure 102, a feed network 104, and a set 106 of IFA elements 108 that are operably coupled to the feed network 104. The antenna system 100 also includes a source 110, which is schematically represented by a box in FIG. 1, that is operably coupled to the feed network 104. The feed network 104 is electrically coupled to the IFA elements 108 and may, when transmitting, supply a varying voltage or current for wideband or multi-band operation. The feed network 104 includes the line(s) that electrically couple the IFA elements to the source 110. For the embodiment of FIG. 1, the feed network 104 includes only a single transmission line and, as such, the feed network 104 will be referred to as the transmission line 104. In other embodiments, however, the feed network may include multiple transmission lines and other components for controlling the set of IFA elements.

For reference, the antenna system 100 is oriented with respect to mutually perpendicular X, Y, and Z axes. The Y axis extends parallel to and through the transmission line 104. As used herein, an element (or a portion thereof) may extend “parallel to” an axis if the element is spaced apart from the axis or if the axis extends through the elements, such as the Y axis extending through the transmission line 104.

In FIG. 1, the set 106 includes only three IFA elements 108. It should be understood that other embodiments may include a different number. For example, alternative embodiments may include only two IFA elements 108 or more than three IFA elements 108 (e.g., 6, 7, 8, 9, 10, 11, 12 IFA elements or more) to cover the desired wideband or multiple bands.

In the illustrated embodiment, the ground structure 102 is a single body that is essentially planar and coincides with the XY plane. In other embodiments, however, the ground structure 102 may not be planar. For example, the ground structure 102 may have non-planar contours. Such instances may occur when the ground structure 102 also functions as a housing for an apparatus or an internal structure that supports other elements of the apparatus. As a particular example, the ground structure 102 may be a portion of a fuselage of an aircraft or an exterior frame of an automobile. In alternative embodiments, the ground structure 102 may include a plurality of separate ground planes that may or may not be electrically coupled to one another.

As shown, the transmission line 104 is a twin-line feed that includes a pair of conductors 121, 122, which may be referred to as first and second conductors 121, 122. The first and second conductors 121, 122 extend between a first line end (or proximal line end) 142 and a second line end (or terminal line end) 144. The first and second conductors 121, 122 may be form an open circuit at the second line end 144, or the first and second conductors 121, 122 may be electrically coupled through a stub or resistor at the second line end 144.

The transmission line 104 is a balanced feed in FIG. 1. The first and second conductors 121, 122 extend parallel to each other along the Y axis in FIG. 1. However, the first and second conductors 121, 122 may not be parallel in other embodiments or may include portions that are parallel and portions that are not parallel in other embodiments. The source 110 may electrically couple to the first and second conductors 121, 122.

The IFA elements 108 include an arm 112 and a shorting stub 114. For each of the IFA elements 108, a feed conductor 116 is directly connected to the arm 112 and provides at least a portion of an electrical pathway to the transmission line 104. The feed conductors 116 may be wires or other conductive elements that are secured at one end to a feed point 117 of the corresponding arm 112 and at an opposite end to an intermediate conductor 118. The intermediate conductors 118 may be directly connected to and extend away from the first conductor 121 or the second conductor 122. The feed points 117 are indicated as dots along the outer sides of the arms 112, but it should be understood that the feed point may occur at the inner side. The intermediate conductor 118 is directly connected to the transmission line 104 or, more specifically, one conductor of the transmission line 104.

In the illustrated embodiment, each of the feed conductors 116 extends through an opening 124 of the ground structure 102. The opening 124 is a closed circular opening that is entirely defined by an interior edge of the ground structure 102. In other embodiments, however, the opening 124 may open to an outer edge of the ground structure 102. The opening 124 may also have any shape. In FIG. 1, the intermediate conductors 118 are positioned below the ground structure 102. In other embodiments, however, the intermediate conductors 118 may have different positions, such as above the ground structure 102 or co-planar with the ground structure 102.

The feed conductor 116 and the intermediate conductor 118 form an electrical pathway between a corresponding arm 112 and the transmission line 104. It is contemplated that the antenna system 100, in other embodiments, may have electrical pathways that include additional intermediate conductors. It is also contemplated that a single conductor may extend from the arm 112 to the transmission line 104.

Each of the shorting stubs 114 is directly connected to a corresponding arm 112 and connected or coupled to the ground structure 102 so that the arm 112 is shorted to the ground structure 102. In FIG. 1, the ground structure 102 is positioned between the IFA element 108 and the transmission line 104. In other embodiments, the transmission line 104 may have another position relative to the ground structure 102, such as above the ground structure 102.

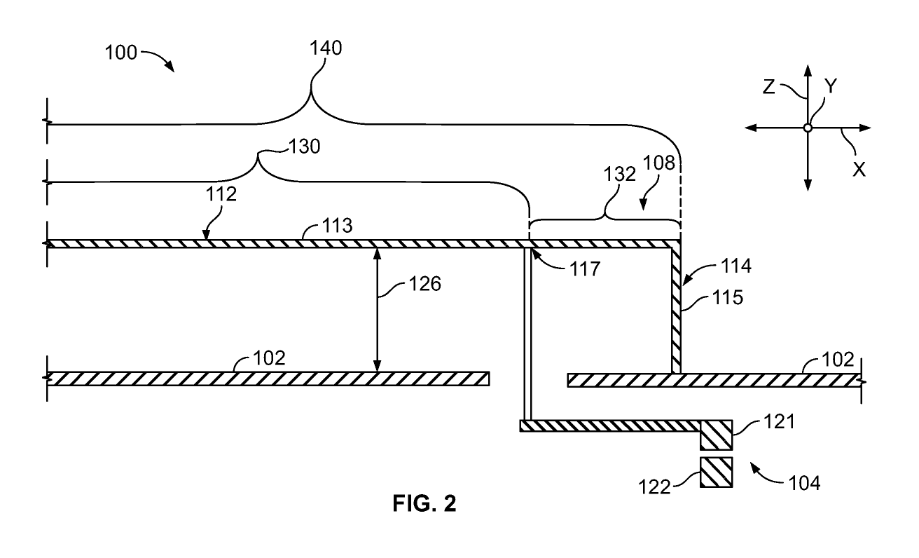

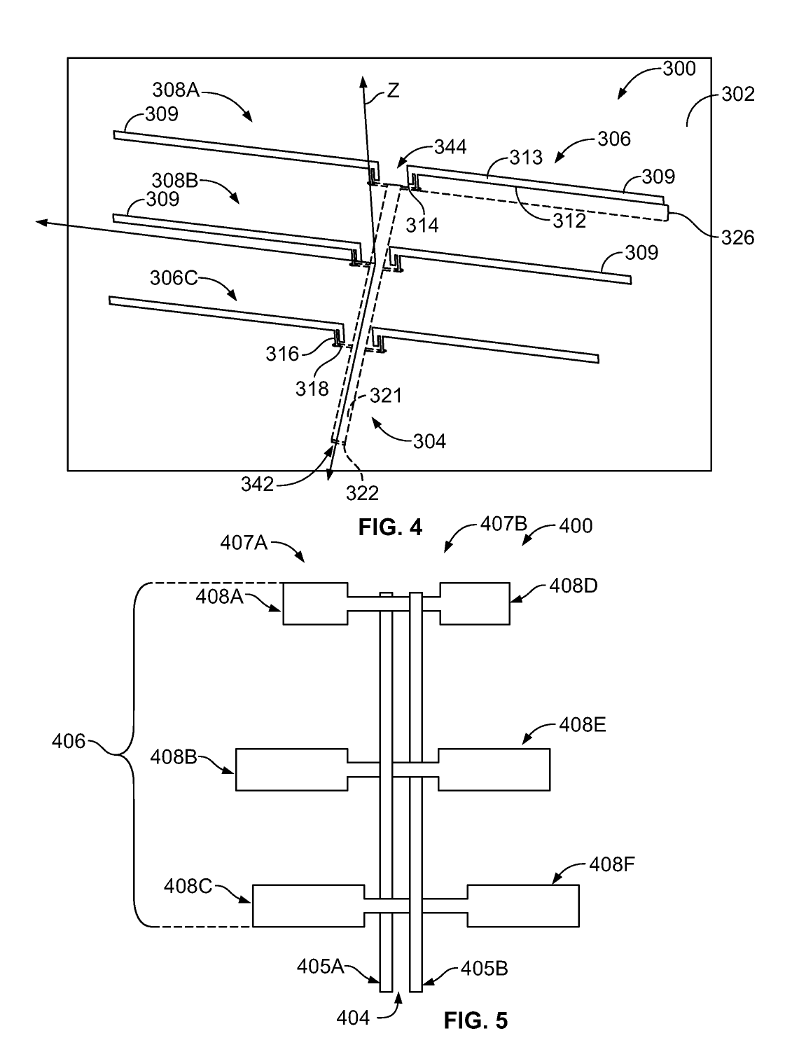

FIG. 2 is a cross-section of the antenna system 100 viewed along the Y-axis and illustrates one of the IFA elements 108 in greater detail. With respect to FIGS. 1 and 2, the IFA elements 108 of FIG. 1 may also be referred to as planar IFA (or PIFA) elements 108. In such cases, the arm 112 and the shorting stub 114 may have respective panel bodies 113, 115. For example, the IFA elements 108 may be stamped and formed from sheet metal. The panel bodies 113 of the arms 112 extend generally parallel to the ground structure 102 at a predetermined height 126 (FIG. 2). The predetermined height 126 may also be referred to as a predetermined space or gap between the arm 112 and the ground structure 102. In other embodiments, the panel bodies 113 may be oriented perpendicular to the ground structure 102, such as the embodiment shown in FIG. 4.

For such embodiments in which the ground structure 102 has a non-planar contour, the panel bodies 113 may have similar contours such that the panel bodies 113 extend generally parallel to the ground structure 102. For example, the fuselage of an aircraft may curve about a longitudinal axis of the aircraft. The panel bodies 113 may be shaped to match the curvature of the fuselage so that the panel bodies 113 extend generally parallel to the fuselage. The term “generally parallel” is used because it is not necessary for the panel bodies 113 to be precisely parallel in order for the IFA elements 108 to function as antennas. The shorting stubs 114 may be generally perpendicular to the ground structure 102 and may extend a length that is equal to the predetermined height 126. In other embodiments, however, the shorting stubs 114 may have panel bodies that are non-planar and, as such, may have lengths that are not equal to the predetermined height 126.

The arms 112 for each of the IFA elements 108 have a respective feed length 130 that extends from the distal end 128 to the feed point 117 and a short length 132 that extends from the feed point 117 to the shorting stub 114. The arms 112 may have a total length 140 that is equal to a sum of the feed length 130 and the short length 132. Also shown, widths 138 (FIG. 1) of the panel bodies 113 are tapered as the panel bodies 113 extend from respective distal ends 128 toward the respective feed points 117. In other embodiments, the panel bodies 113 may have different shapes. For example, the panel bodies 113 may be rectangular.

Various portions or sections of the IFA elements may be configured to achieve a desired performance of the corresponding IFA elements. For example, the feed lengths 130, the short lengths 132, the shape of the panel bodies 113, the shape of the shorting stub 114, the location of the feed point 117 relative to the shorting stub 114 and the distal end 128 may be configured with respect to one another to achieve a desired performance.

In FIG. 1, each of the arms 112 has a single panel body 113 and is directly connected to a single shorting stub 114. In other embodiments, the arms 112 may include additional elements that are directly connected to the panel body 113. For example, the arms 112 may include one or more other panel bodies (not shown) that are directly or indirectly connected to the panel body 113. Likewise, each of the IFA elements 108 may include more than one shorting stub.

Also shown in FIG. 1, the IFA elements 108 extend parallel to one another in a common direction along the X axis. The transmission line 104 is linear and the IFA elements 108 are spaced apart along the X axis (or the transmission line 104) such that designated gaps 134 exist between adjacent IFA elements 108. In addition to the other parameters described above, the designated gaps 134 may be configured so that the antenna system 100 achieves a designated performance. In the illustrated embodiment, the gaps 134 reduce in size as the arms 112 extend from the shorting stub 114 to the distal ends 128. In other embodiments, the gaps 134 may be uniform from the shorting stubs 114 to the distal ends 128 or may reduce in size.

In some embodiments, the designated height 126 (FIG. 2) may be configured such that the antenna system 100 has a low-profile. For example, the designated height 126 of a corresponding IFA element 108 may be less than λ/10, wherein λ is the wavelength (in metric units) of the resonant frequency (in MHz) of the respective IFA element 108. In some embodiments, the designated height 126 of a corresponding IFA element 108 may be less than λ/15, may be less than λ/20, or may be less than λ/25. As a non-limiting example, a maximum height of the designated heights 126 (e.g., the tallest of the IFA elements 108) may be less than 15 centimeters. In more particular embodiments, the maximum height may be less than 10 centimeters, less than 8 centimeters, or less than 6 centimeters.

In some embodiments, the total length 140, the feed length 130, the short length 132, and/or the designated height 126 (FIG. 2) of one IFA element 108 may differ with respect to the other IFA elements 108. The IFA elements 108 of the set 106 may have different respective resonant frequencies. In FIG. 1, for example, the total lengths 140 increase as the transmission line 104 extends along the X-axis toward the terminal line end 144. In some embodiments, the IFA elements 108 are configured to provide a log-periodic progression of frequencies for wideband operation. In other embodiments, however, the IFA elements 108 may have different dimensions with respect to one another that do not satisfy a log-periodic progression. For example, although the total lengths 140 may increase as the IFA elements 108 extend away from the source 110, the total lengths 140 may not satisfy a log-periodic progression. The resonant frequencies may be configured for multi-band operation. Yet in other embodiments, the IFA elements 108 may not progressively or successively increase. For example, the middle IFA element 108B shown in FIG. 1 may be longer than the IFA elements 108C and 108A.

Also shown in FIG. 1, the set 106 of the IFA elements 108 are fed by the transmission line 104 such that adjacent IFA elements 108 are fed by different conductors of the transmission line 104. More specifically, the adjacent antenna elements 108 may be fed with opposite input phases (0 degrees or 180 degrees). In FIG. 1, the transmission line 104 is a balanced twin-line feed. The IFA elements 108A and 108C are electrically coupled and fed by the first conductor 121. The IFA element 108B, which is positioned between the IFA elements 108A, 108C and adjacent to each of the IFA elements 108A, 108C, is electrically coupled to and fed by the second conductor 122. In other embodiments that include more IFA elements 108, the alternating feed pattern may continue such that adjacent IFA elements 108 are fed by different conductors of the transmission line 104.

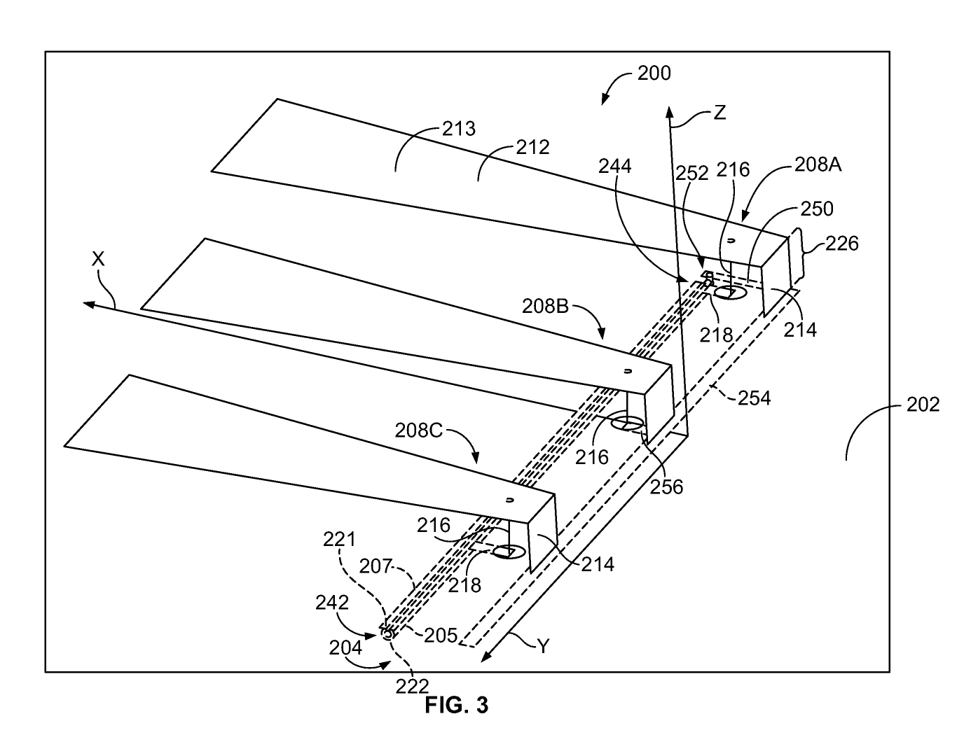

FIG. 3 is a perspective view of an antenna system 200 formed in accordance with an embodiment. The antenna system 200 may include elements and/or features that are similar to or identical to the antenna system 100 (FIG. 1). For example, the antenna system 200 includes a ground structure 202 and a transmission line 204 having first and second conductors 221, 222. The first and second conductors 221, 222 of the transmission line 204 extend between a first line end (or proximal line end) 242 and a second line end (or terminal line end) 244. The antenna system 200 also includes a set 206 of IFA elements 208A-208C. Only three IFA elements 208A-208C are shown in FIG. 3, but more or less IFA elements may be used in other embodiments.

The IFA elements 208A-208C may be configured to have different respective resonant frequencies. Each of the IFA elements 208A-208C has an arm 212 that is spaced apart from the ground structure 202 by a designated height 226 and extends along the ground structure 202 for at least a portion of the arm 212. Each of the IFA elements 208A-208C also has a shorting stub 214 that is coupled to the arm 212 and to the ground structure 202. Optionally, the IFA elements 208A-208C may be planar IFA (PIFA) elements in which the arms 212 form panel bodies 213, which may be oriented parallel to or perpendicular to the ground structure 202. The set of IFA elements 208A-208C are configured to be fed by the transmission line 204 such that adjacent IFA elements 208A-208C are fed by different conductors of the transmission line 204.

Unlike the transmission line 104 (FIG. 1), however, the transmission line 204 is an unbalanced feed line. As shown, the transmission line 204 includes a coaxial cable 205 having the first and second conductors 221, 222. For embodiments in which the transmission line 204 includes a coaxial cable or line, the first conductor 221 may be an outer conductor, and the second conductor 222 may be an inner conductor (or center conductor) that is surrounded by the outer conductor. Alternatively, the first and second conductors may be the inner and outer conductors, respectively. The transmission line 204 also includes a coupling conductor 207, which is a trace that extends along the first conductor 221 of the coaxial cable 205 in the illustrated embodiment. In other embodiments, the transmission line 204 may be a microstrip line or stripline.

Similar to the transmission line 104, the IFA elements 208A-208C may have respective resonant frequencies that form a log-periodic progression of frequencies for wideband operation. In other embodiments, however, the IFA elements 208A-208C may have different dimensions with respect to one another that do not satisfy a log-periodic progression. The resonant frequencies may also be configured for multi-band operation. Yet in other embodiments, the IFA elements 208A-208C may not progressively or successively increase.

As shown in FIG. 3, the transmission line 204 or the coaxial cable 205 is disposed under the ground structure 202. The transmission line 204 extends parallel to the Y axis and under the arms 212 of the IFA elements 208A-208C. The antenna system 200 includes local intermediate conductors 218 that are directly connected to and extend away from the coupling conductor 207. Alternatively, the local intermediate conductors 218 may be directly connected to and extend away from the outer conductor 221.

The local intermediate conductors 218 are electrically coupled to two of corresponding arms 212 of the IFA elements 208A, 208C through feed conductors 216. At or proximate to the second line end 244, the antenna system 200 also includes a lateral intermediate conductor 250 that extends between an electrical connector 252 and a longitudinal intermediate conductor 254. The electrical connector 252 is directly connected to the second conductor 222 (or inner conductor 222) of the coaxial cable 205.

The longitudinal intermediate conductor 254 extends toward the first line end 242 and the IFA element 208B. For example, the longitudinal intermediate conductor 254 extends parallel to the first and second conductors 221, 222. Optionally, the intermediate conductor 254 may extend toward the source (not shown). A local intermediate conductor 256 extends from the longitudinal intermediate conductor 254, whereby a feed conductor 216 electrically couples the local intermediate conductor 256 to the arm 212 of the IFA element 208B.

As such, an electrical pathway between the second conductor 222 of the coaxial cable 205 and the IFA element 208B may be formed through the electrical connector 252, the lateral intermediate conductor 250, the longitudinal intermediate conductor 254, the local intermediate conductor 256, and the feed conductor 216. In other embodiments, the electrical pathway may include more or fewer conductors. In such embodiments the transmission line 204 may be an unbalanced transmission line. The first conductor 221 of the transmission line 204 is directly connected to every other IFA element 208A, 208C and the second conductor 222 is directly connected to the other IFA element 208B. If the antenna system 200 included additional IFA elements 208, the second conductor 222 could be directed connected to at least one other IFA element 208.

FIG. 4 is a perspective view of an antenna system 300 formed in accordance with an embodiment. The antenna system 300 may include elements and/or features that are similar to or identical to the antenna system 100 (FIG. 1) and the antenna system 200 (FIG. 3). For example, the antenna system 300 includes a ground structure 302 and a transmission line 304 having first and second conductors 321, 322. The first conductor 321 is a top conductor and the second conductor 322 is a bottom conductor that is disposed under the first conductor 321. The first and second conductors 321, 322 of the transmission line 304 extend between a first line end (or proximal line end) 342 and a second line end (or terminal line end) 344. The antenna system 300 also includes a set 306 of pairs 308A-308C of IFA elements 309. Only three pairs 308A-308C of IFA elements 309 are shown in FIG. 3, but more or less pairs of IFA elements may be used in other embodiments.

Each of the IFA elements 309 has an arm 312 that is spaced apart from the ground structure 302 by a designated height 326 and extends along the ground structure 302 for at least a portion of the arm 312. Each of the IFA elements 309 also has a shorting stub 314 that is coupled to the arm 312 and to the ground structure 302. Optionally, the IFA elements 309 may be planar IFA (PIFA) elements in which the arms 312 form panel bodies 313, which may be oriented perpendicular to the ground structure 302 as shown in FIG. 4. Alternatively, the panel bodies 313 may be oriented parallel to the ground structure 302. The antenna system 300 also includes intermediate conductors 318 and feed conductors 316 that electrically couple the arms 312 to the corresponding conductor of the transmission line 304.

The pairs 308A-308C of IFA elements 309 may be configured to have different respective resonant frequencies. Each of the IFA elements 309 of a single pair may have a common or equivalent resonant frequency, and the two IFA elements 309 of the pair are oriented or positioned antiparallel to each other. Each of the IFA elements 309 of a single pair is electrically coupled to the same conductor of the transmission line 304. More specifically, the two IFA elements 309 of the pair 308C are electrically connected to the first conductor 321. The two IFA elements 309 of the pair 308B are electrically connected to the second conductor 322, and the two IFA elements 309 of the pair 308A are electrically connected to the first conductor 321. Unlike the IFA elements 108 (FIGS. 1) and 208 (FIG. 3), the IFA elements 309 of each pair are fed with the same phase and IFA elements 309 of adjacent pairs are fed in the opposite phase. In such embodiments, horizontal components of radiation may cancel each other, thereby causing a radiation pattern that is more azimuthally symmetric and less directional than other antenna systems that do not include the configuration of FIG. 4. Thus, in some embodiments, the set 306 of IFA elements 309 may be configured such that a radiation pattern of the antenna system 300 is predominantly vertically polarized and predominantly azimuthally-omnidirectional.

FIG. 5 is a schematic diagram of an antenna system 400 formed in accordance with an embodiment. The antenna system 400 may include elements and/or features that are similar to or identical to the antenna system 100 (FIG. 1), the antenna system 200 (FIG. 3), and/or the antenna system 300 (FIG. 4). For example, the antenna system 400 includes a set 406 of IFA elements 408 that are arranged in two sub-sets 407A, 407B. In FIG. 5, the IFA elements 408 are positioned in a similar configuration as the IFA elements 309 (FIG. 4). In other embodiments, the IFA elements 408 may be positioned in a similar configuration as the IFA elements 108 (FIG. 1) or 208 (FIG. 3). As one example, the IFA element 408D may be positioned between the IFA elements 408A and 408B, the IFA element 408E may be positioned between the IFA elements 408B and 408C, and the IFA element 408F may be disposed adjacent to the IFA element 408C.

In FIG. 5, the antenna system 400 includes a feed network 404 having two transmission lines 405A, 405B. Each of the transmission lines 405A, 405B is configured to control a different sub-set of the set 406 of the IFA elements 408. For example, the transmission line 405A may control the sub-set 407A that includes the IFA elements 408B and 408E in a similar manner as the transmission line 104 (FIG. 1), the transmission line 204 (FIG. 3), or the transmission line 304 (FIG. 4). The transmission line 405B may control the sub-set 407/B of the IFA elements 408A, 408C, 408D, and 408F in a similar manner. Collectively, the IFA elements 408A-408F may be controlled for wideband or multi-band operation.

Accordingly, in some embodiments, the antenna systems described herein may combine the principles of an IFA with principles of an LPDA to create a log periodic inverted-F antenna (LP-IFA). As described herein, a set of inverted-F antenna elements may be chosen with a log periodic progression of lengths, diameters (or like dimension), and/or spacings. The set of IFAs may be fed using a traveling-wave technique similar to those used for an LPDA. Accordingly, a wideband array capable of functioning while electrically close to a ground structure may be provided.

In particular embodiments, the antenna may be low profile, but its radiation pattern may be vertically polarized and approximately omnidirectional in azimuth. This may be achieved through selection of the antenna element resonant frequencies and spacings. At a particular frequency, a conventional LPDA may be considered to operate with one or more resonant elements, one or more director elements, and one or more reflector elements. In particular embodiments, antenna systems described herein may be considered to operate with one or more resonant elements and one or more reflector elements due to the selective of the element resonant frequencies. The absence of director elements may change the shape of the radiation pattern from the forward direction to an azimuthally-omnidirectional pattern. As such, the performance of such antenna systems may substantially differ from the performance of conventional log periodic arrays. The antenna system may operate in close proximity to a ground structure, over wideband, with vertically-polarized radiation, and with an azimuthally-symmetric pattern.

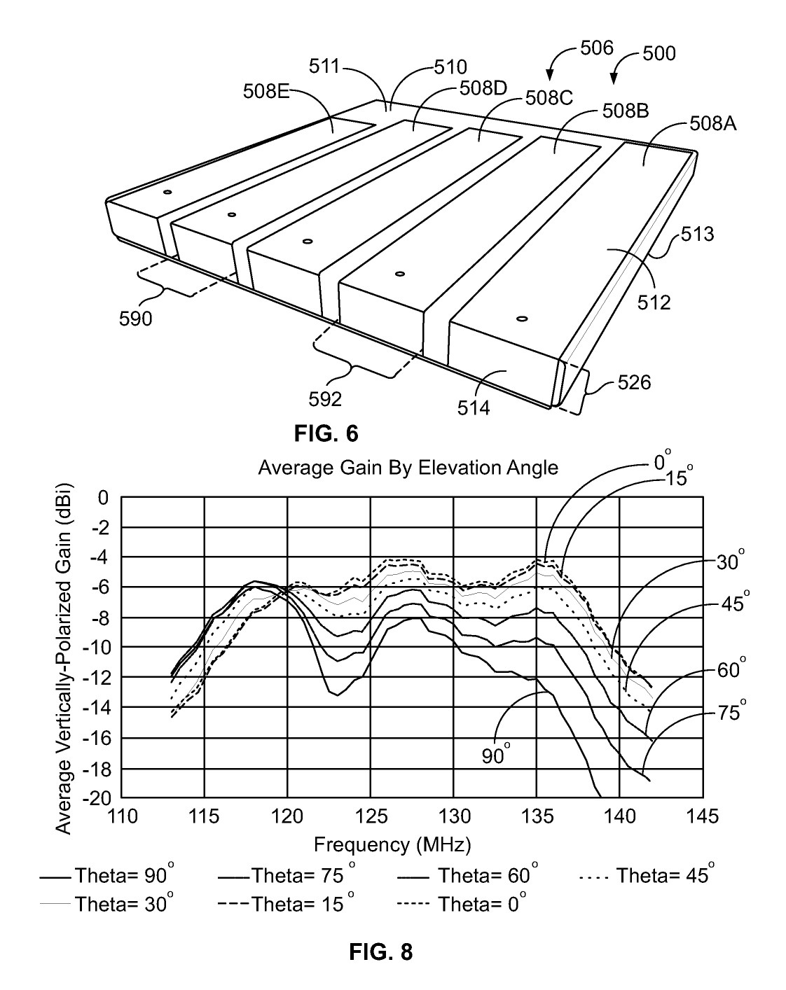

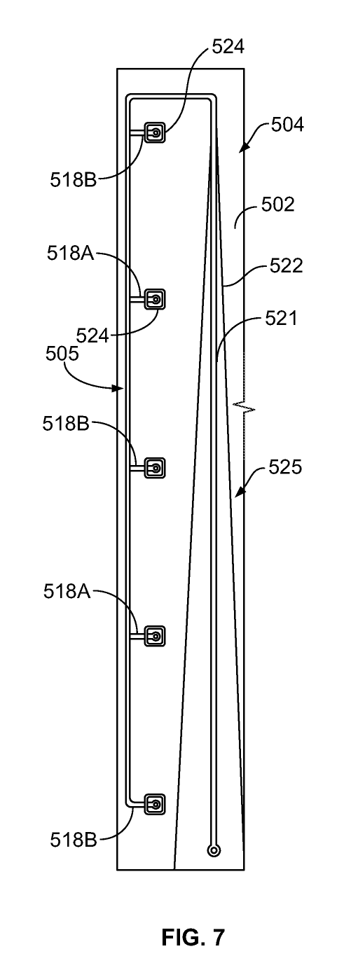

FIG. 6 is a perspective view of an antenna system 500 in accordance with an embodiment, FIG. 7 is a plan view of a feed network 504 of the antenna system 500 that includes a transmission line 505. Although the feed network 504 has different layers, the feed network 504 is shown in solid lines for illustrative purposes. The antenna system 500 and feed network 504 may be similar to other embodiments described herein. For example, with respect to FIG. 7, the transmission line 505 is a twin-line feed having first and second conductors 521, 522 and includes a linear tapered balun 525. The second conductor 522 is positioned below the first conductor 521 in FIG. 7. The topology of the feed network 504 is stripline. As shown, the feed network 504 also include intermediate conductors 518A, 518B that extend from the first conductor 521 or the second conductor 522 and couple to feed conductors (not shown) that extend through openings 524 in a ground structure 502. The first conductor 521 electrically couples to intermediate conductors 518A, and the second conductor 522 electrically couples to intermediate conductors 518B. The intermediate conductors 518A, 518B feed inverted-F antenna (IFA) elements 508 (shown in FIG. 6). The IFA elements 508 are alternatingly fed such that adjacent elements 508 are fed by different conductors of the transmission line 505.

Turning to FIG. 6, the antenna system 500 includes a set 506 of the IFA elements 508A, 508B, 508C, 508D, and 508E. The IFA elements 508A-508E each have arms 512 that are spaced apart from the ground structure 502 (FIG. 7) and shorting stubs 514 that couple the arm 512 to the ground structure 502. The arms 512 are shaped to have different resonant frequencies. In the embodiment of FIG. 6, the arms 512 have a designated height 526.

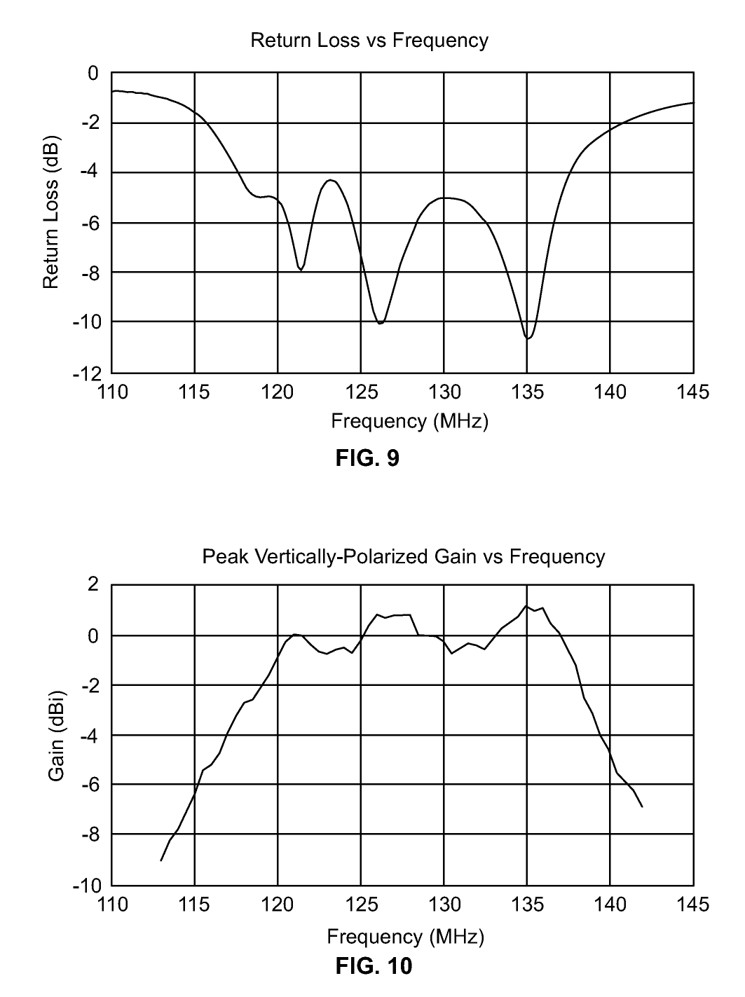

The arms 512 of the IFA elements 508A-508E extend parallel to one another in a common direction and have different lengths. In FIG. 6, the arms 512 are supported by a support block 510, which may be a rigid block of material. More specifically, the support block 510 is disposed between the arms 512 and the ground structure 502 (FIG. 5). The arms 512 are positioned along an exterior side 511 of the support block 510. An inner side 513, which is opposite the exterior side 511, may extend along and interface with (e.g., engage or have a small gap therebetween) the support structure 502. The support block 510 may be used during manufacturing of the antenna system 500, shipping of the antenna system 500, testing of the antenna system 500, and/or operation of the antenna system 500. For the test results shown in FIGS. 8-10, the support block 510 was positioned as shown in FIG. 6.

By way of example, the support block 510 may be a rigid foam, such as a polymethacrylimide foam (e.g., Evonik Rohacell® WF polymethacrylimide foam). In some embodiments, the support block may be shaped to include recesses, channels, or slots that receive portions of the antenna system. For example, for embodiments in which the arms are vertically-oriented, the support block may include vertical slots for receiving the arms. It should be understood, however, that the support block may have a variety of configurations and shapes. The support block may also be configured to engage an enclosure of the antenna elements (e.g., radome). The enclosure may extend over the entire set 506 of IFA elements 508A-508E.

In the illustrated embodiment, the height 526 is 2.00 inches (or 5.08 centimeters (cm)) and the lengths of the IFA elements 508A-508E have the following progression: 24.00 in (or 60.96 cm), 22.39 in (or 56.87 cm), 21.53 in (or 54.69 cm), 20.66 in (or 52.48 cm), 19.89 in (or 50.52 cm), and 19.12 in (or 58.56 cm). A center-to-center spacing 590 of the IFA elements 508 is 5.00 in (or 12.70 cm), and a width 592 of each shorting stub is 4.00 in (or 10.16 cm). The arms 512 are equally spaced apart.

FIGS. 8-10 illustrate test results of the performance of the antenna system 500.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The patentable scope should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

What is claimed is:

1. An antenna system comprising:
a ground structure;
a transmission line having first and second conductors; and
a set of inverted-F antenna (IFA) elements having different respective resonant frequencies, each of the IFA elements having an arm that is spaced apart from the ground structure by a designated height and extends along the ground structure for at least a portion of the arm, each of the IFA elements having a shorting stub that is connected or coupled to the arm and to the ground structure, the set of IFA elements configured to be fed by the transmission line such that adjacent IFA elements are fed by different conductors of the transmission line.

2. The antenna system of claim 1, wherein the respective resonant frequencies form a log-periodic progression of frequencies for wideband operation.

3. The antenna system of claim 1, wherein the respective resonant frequencies are configured for multi-band operation.

4. The antenna system of claim 1, wherein the first and second conductors form a twin-line feed, the IFA elements including first, second, and third IFA elements that are alternatingly fed by the first and second conductors.

5. The antenna system of claim 4, wherein the arms of the IFA elements extend parallel or antiparallel to one another.

6. The antenna system of claim 4, further comprising intermediate conductors that are directly connected to and extend away from the first conductor or the second conductor, the intermediate conductors being electrically connected or coupled to corresponding arms of the IFA elements.

7. The antenna system of claim 1, wherein the transmission line is an unbalanced transmission line, the first conductor of the transmission line being directly connected to every other IFA element and the second conductor of the transmission line being directly connected to the other IFA element or IFA elements.

8. The antenna system of claim 1, wherein the IFA elements are planar IFA (PIFA) elements in which the arms form panel bodies that are oriented parallel to the ground structure.

9. The antenna system of claim 8, wherein a width of the panel bodies tapers as the panel bodies extend from respective distal ends toward respective feed points.

10. The antenna system of claim 1, wherein the IFA elements are planar IFA (PIFA) elements in which the arms form panel bodies that are oriented perpendicular to the ground structure.

11. The antenna system of claim 1, wherein the designated height of the IFA element is less than V10, wherein X, is the wavelength of the resonant frequency of the respective IFA element.

12. The antenna system of claim 1, wherein a maximum height of the designated heights is less than 15 centimeters.

13. The antenna system of claim 1, wherein the IFA elements form IFA pairs in which the two IFA elements of each IFA pair are aligned with each other and positioned anti-parallel to each another, the IFA elements of each pair being fed by the same conductor of the transmission line, wherein adjacent IFA pairs are fed by different conductors of the transmission line.

14. The antenna system of claim 13, wherein the set of IFA elements are configured such that a radiation pattern of the antenna system is predominantly vertically polarized and predominantly azimuthally-omnidirectional.

15. An antenna system comprising:
a ground structure;
a set of inverted-F antenna (IFA) elements configured to be electrically coupled to a feed network, each of the IFA elements having an arm that is spaced apart from the ground structure by a designated height and extends along the ground structure for at least a portion of the arm, each of the IFA elements having a shorting stub that is connected or coupled to the arm and to the ground structure, wherein the IFA elements have respective resonant frequencies that are configured to form a log-periodic progression of frequencies for wideband operation.

16. The antenna system of claim 15, further comprising the feed network, the feed network including a transmission line having first and second conductors, the set of IFA elements configured to be fed by the transmission line in which adjacent IFA elements are fed by different conductors of the transmission line.

17. The antenna system of claim 15, further comprising the feed network, wherein the feed network includes at least two transmission lines, each of the transmission lines controlling a different sub-set of the IFA elements.

18. The antenna system of claim 15, wherein the IFA elements are planar IFA (PIFA) elements in which the arms form panel bodies that are oriented parallel to or perpendicular to the ground structure.

19. The antenna system of claim 15, wherein the arms of the IFA elements extend parallel or antiparallel to one another.

20. The antenna system of claim 15, wherein the IFA elements form IFA pairs in which the two IFA elements of each IFA pair are aligned with each other and positioned anti-parallel to each another, the IFA elements of each IFA pair being configured to have the same resonant frequency.
